(19) United States
(12) Patent Application Publication
(10) Pub. No.: US 2010/0158775 A1
(43) Pub. Date: Jun. 24, 2010

(54) Catalyst Systems and Methods for Treating Aircraft Cabin Air

(75) Inventors: Michael P. Galligan, Cranford, NJ (US); Mark Buelow, Phillipsburg, NJ (US); Martin Volland, Jersey City, NJ (US); Pascaline Harrison Tran, Holmdel, NJ (US); Bruce J. Frishberg, Manalapan, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/338,802

(22) Filed: Dec. 18, 2008

(51) Int. Cl. B01D 53/66; B01J 23/745; B01J 23/86; B01J 23/83; B01J 21/18; B01J 21/02

(52) U.S. Cl. 423/219; 502/338; 502/316; 502/303; 502/185; 502/314

(57) ABSTRACT

Air treatment catalyst systems and methods for treating the air in the aircraft cabin environment are provided. The catalyst system and method remove ozone, volatile organic compounds, NOx and other pollutants. The catalyst system used to treat the cabin air comprises a plurality of discrete substrates having an ozone abatement catalyst loaded thereon and arranged in a stacked configuration between a source of the air stream and the passenger cabin, the at least the first two substrates adjacent the source of the air stream comprise an iron-based alloy.

### TECHNICAL FIELD

Embodiments of the present application relate to air treatment systems and methods of treating the cabin air of an aircraft.

### BACKGROUND

During flight or operation of aircraft, the air within the cabin environment is continuously treated and replenished with fresh air. The existing air is continuously recirculated and filtered to remove contaminants such as viruses and bacteria, and portions of this existing air is also exhausted and replenished. The fresh air used to replenish the exhausted cabin air during operation or flight is taken in from the atmosphere, treated and then mixed with the recirculated cabin air. In some instances, the air from the atmosphere is further treated to remove pollutants.

Aircraft typically fly at higher altitudes for more fuel-efficient operation. At higher altitudes, the atmosphere contains a high level of ozone, and ozone plumes encountered at some altitudes have even higher ozone concentrations. The presence of ozone in the atmosphere can provide protection from ultra-violet rays but can also be harmful when inhaled. This air and the air existing within aircraft cabins contain many other components in addition to ozone including NOx, volatile organic compounds (“VOCs”) and other undesired compounds and particulate matter. This air from the atmosphere is typically supplied to the cabin through the engine of the aircraft. As outside air enters the compressor of the engine, it is compressed and heated to a higher pressure and temperature. The heated and pressurized air from the engine, commonly referred to as “bleed air,” is extracted from the compressor by bleed air ports which control the amount of air extracted. The bleed air is fed to an environmental control system (“ECS”).

After the bleed air passes through the catalyst and ECS, during which ozone and other pollutants may be removed and the temperature and pressure adjusted, the bleed air is sometimes circulated to the air-conditioning packs where it is further cooled to a set temperature for introduction to the cabin.

The existing air from the cabin is filtered, recirculated to the air treatment system and mixed with the bleed air. The mixture of recirculated cabin air and bleed air is then supplied to the cabin. A plurality of honeycomb catalysts serially arranged in a canister are utilized to treat the cabin air to remove ozone and other pollutants. Typically, the catalyst members are made from an aluminum substrate having a catalytic coating thereon.

Catalyst systems and elements in certain aircraft, such as military aircraft, encounter severe environmental conditions that may cause the catalyst to wear. For example, the air stream distributed through a catalyst system in a military aircraft may contain sand and other particulate matter that may cause the catalyst elements to wear prematurely. It would be desirable to provide catalysts systems and methods that exhibit improved durability.

### SUMMARY

One or more aspects of the present invention pertain to a catalyst system for treating ozone in an air stream that enters a passenger cabin of an aircraft. In accordance with one or more embodiments, the catalyst system may include a plurality of discrete substrates. The plurality of substrates of a specific embodiment include an ozone abatement catalyst loaded thereon. In accordance with one or more embodiments, the ozone abate catalyst may include a manganese component.

In one or more embodiments, the plurality of substrates are serially arranged and may also be arranged in a stacked configuration between the source of an air stream and the passenger cabin. According to one or more embodiments, the plurality of substrates may also each include a honeycomb. The substrates utilized in one or more embodiments may also be disposed within a canister and may be arranged in a spaced relationship within the canister.

In accordance with one or more embodiments, the first two substrates of the plurality of substrates disposed adjacent to the air stream may include an iron-based alloy. In a specific embodiment, the first two substrates disposed adjacent to the air stream include an iron-chromium alloy. One or more embodiments may also utilize substrates which include aluminum. In such embodiments, the aluminum substrates are disposed downstream from the air stream and may also be disposed downstream of the first two substrates which may include iron-based and/or iron-chromium alloy substrates. In one or more embodiments the substrates disposed downs stream of the air stream may also comprise a ceramic material. Such substrates may also be disposed downstream from the first two substrates which may include an iron-based substrate and/or an iron-chromium alloy substrate.

In one or more embodiments, the iron-based alloy has a density in the range of about 6.9 g/cm³ to about 7.2 g/cm³. The iron-chromium alloy utilized in one or more specific embodiments, may include one or more of iron, chromium, aluminum, lanthanum, ceria, lanthanum and ceria in combination, and combinations thereof. In one or more such embodiments, iron is present in the range from about 60 weight % to about 80 weight %. In a specific embodiment, the iron is present an amount in the range from about 70 weight % to about 80 weight % and, in an more specific embodiment, the iron is present in an amount in the range from about 76 weight % to about 80 weight %.

One or more embodiments utilizing an iron-chromium alloy may include chromium present in the range from about 15 weight % to about 30 weight %. In a specific such embodiment, the chromium may be present in an amount in the range from about 20 weight % to about 25 weight % and, in a more specific embodiment, the chromium may be present in an amount in the range from about 14 weight % to about 17%.

The iron-chromium alloy utilized in one or more embodiments may also include aluminum in the range of about 2 weight % to about 10 weight %. In one or more specific embodiments, the iron-chromium alloy may include alumina in the range from about 4 weight % to about 8 weight % and, in a more specific embodiment, the alumina may be present in the range from about 5 weight % to about 6 weight %.

The iron-chromium alloys used in one or more embodiments may include lanthanum and ceria present in a combined amount of less than about 1 weight % or, in accordance with a more specific embodiment, less than about 0.5 weight %.

Alternative embodiments of the present invention utilize iron-chromium alloys which include carbon, manganese, silicon, sulfur and/or combinations thereof. In one such embodiment, the iron-chromium alloy includes carbon in an amount up to about 0.5 weight %, manganese in an amount up to about 1 weight %, silicon in an amount up to about 1 weight %, sulfur in an amount up to about 0.5 weight % and/or combinations thereof.

Another aspect of the present invention pertains to a method of treating ozone in an air stream entering a passenger cabin of an aircraft. In one or more embodiments, the method includes placing a plurality of discrete substrates, which may be serially arranged, between a source of the air stream and the passenger cabin. In such embodiments, the plurality of substrates may include an ozone abatement catalyst loaded thereon.

In a specific embodiment, the method utilizes a plurality of substrates wherein the first two substrates disposed adjacent to the air stream include an iron-based alloy, which, in a specific embodiment, may include an iron-chromium alloy. In a more specific embodiment, the substrates may include an iron-based alloy with a density in the range from about 6.9 g/c^{m3} to about 7.2 g/cm^{m3}. In one or more embodiments, each substrate includes a honeycomb and, in a specific embodiment, the each substrate includes a honeycomb, the first two of which may include an iron-chromium alloy honeycomb. In a more specific embodiment, the first two iron-chromium alloy substrates are disposed within a canister and may be arranged in a spaced relationship within the canister.

The iron-chromium alloy utilized in one or more specific embodiments of the methods described herein, may include one or more of iron, chromium, aluminum, lanthanum, ceria, lanthanum and ceria in combination, and combinations thereof. In one or more embodiments, the iron-based alloy has a density in the range of about 6.9 g/cm³ to about 7.2 g/cm³. In one or more such embodiments, iron is present in the range from about 60 weight % to about 80 weight %. In a specific embodiment of the method, the iron is present an amount in the range from about 70 weight % to about 80 weight % and, in an more specific embodiment, the iron is present in an amount in the range from about 76 weight % to about 80 weight %.

One or more embodiments of the method utilizing an iron-chromium alloy may include chromium present in the range from about 15 weight % to about 30 weight %. In a specific embodiment of the method, the chromium may be present in an amount in the range from about 20 weight % to about 25 weight % and, in a more specific embodiment, the chromium may be present in an amount in the range from about 14 weight % to about 17%.

The iron-chromium alloy utilized in one or more embodiments of the method may also include aluminum in the range of about 2 weight % to about 10 weight %. In one or more specific embodiments of the method, the iron-chromium alloy may include alumina in the range from about 4 weight % to about 8 weight % and, in a more specific embodiment, the alumina may be present in the range from about 5 weight % to about 6 weight %.

The iron-chromium alloys used in one or more embodiments of the method may include lanthanum and ceria present in a combined amount of less than about 1 weight % or, in accordance with a more specific embodiment, the combined amount of lanthanum and ceria is less than about 0.5 weight %.

Alternative embodiments of the method utilize iron-chromium alloys which include carbon, manganese, silicon, sulfur and/or combinations thereof. In one such embodiment, the iron-chromium alloy includes carbon in an amount up to about 0.5 weight %, manganese in an amount up to about 1 weight %, silicon in an amount up to about 1 weight %, sulfur in an amount up to about 0.5 weight % and/or combinations thereof.

### BRIEF DESCRIPTION OF THE DRAWINGS

A more complete appreciation of the subject matter of the present invention can be realized by reference to the following detailed description in which reference is made to the accompanying drawings depicting exemplary embodiment of the invention in which:

FIG. 1 illustrates an aircraft air treatment system in accordance with an embodiment of the invention;

FIG. 2 illustrates a honeycomb substrate; and

FIG. 3 is a perspective view of a catalyst system according to one embodiment.

### DETAILED DESCRIPTION

The system for treating air and method for treating aircraft cabin air, according to one or more embodiments of the invention, may be more readily appreciated by reference to the Figures, which are merely exemplary in nature and in no way intended to limit the invention or its application or uses. Before describing these several exemplary embodiments of the invention, it is to be understood that the invention is not limited to the details of construction or process steps set forth in the following description. The invention is capable of other embodiments and of being practiced or being carried out in various ways.

Embodiments of the present invention relate an air treatment system with one or more catalysts disposed to treat the compressed air, recirculated air and/or the combined compressed and recirculated air. The air treatment system of the present invention includes one compressor or compressed air source, ECS, mixer, a recirculation air system and a catalyst.

As used throughout this application, the term “Environmental Control System” (abbreviated as “ECS”) shall include, without limitation, a system that controls one or more of the pressure, temperature, humidity and pollutant levels of the air supplied to the cabin, regardless of whether the air is bleed air or bleedless air (as defined herein). A mixer shall be defined to include any known means for combining air sources which can include the compressed air and recirculated air. The air treatment system may include a catalyst to remove the ozone from the bleed air. As used throughout this application, the terms “treat,” “remove” and “remove pollutants” shall cover at least conversion of ozone, carbon monoxide, hydrocarbons and VOCs and/or adsorption of the foregoing.

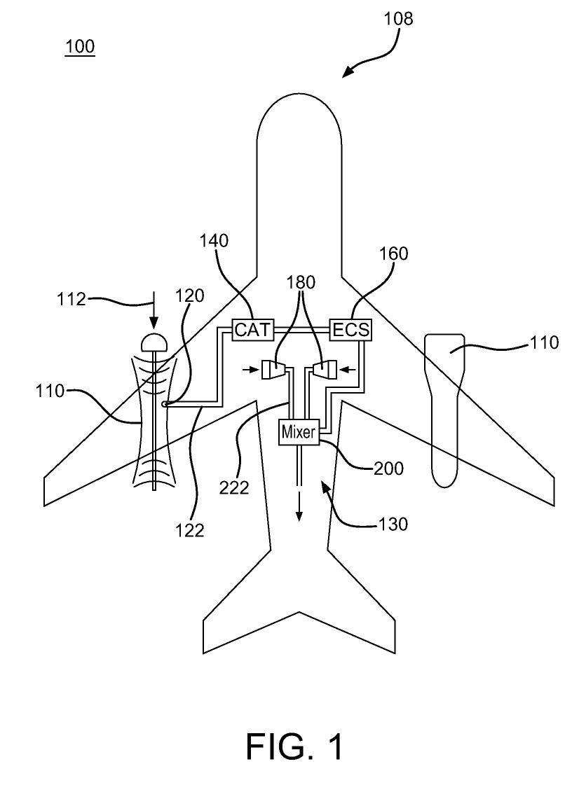

As shown in FIG. 1, an example of a typical air treatment system 100 for an aircraft 108 is shown. In embodiments utilizing bleed air as compressed air, upon entering the engine 110, the outside or fresh air (shown as the arrow 112 entering the engine 110) is compressed and heated to a higher pressure and temperature. A portion of this air flowing through the engine 110 is directed through the air treatment system 200 and through one or more delivery ports 120 and into first conduit 122. The bleed air then travels through conduit 122 within the air distribution system 200 to the environmental control system 160. The air treatment system 200 includes a recirculation air system 180 which recirculates and filters the air within the cabin 130 of the aircraft 108t. In one or more embodiments, the recirculation air system 180 draws or takes in the air from the cabin through the ceiling or from under floor spaces. Air flowing from the recirculation air system 600 and the environmental control system are combined in mixer 200 prior to delivery into cabin 130.

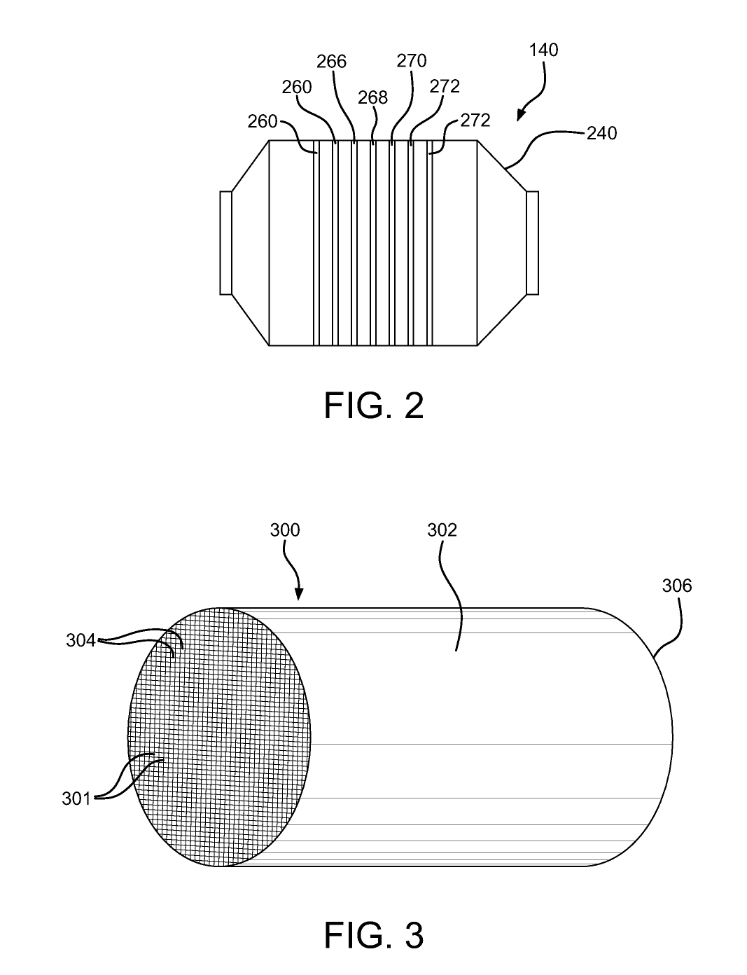

The catalyst 140 is shown in more detail in FIG. 2, and typically comprises a plurality of catalyst substrates disposed in a metal canister 250. The catalyst 140 comprising the canister 250 and the substrates 250 is disposed in the path of the air stream as shown in FIG. 1. According to an embodiment of the present invention a plurality of discrete substrates 260, 262, 264, 266, 268, 270, 272, are serially arranged in a stacked configuration in canister 240 in a spaced apart relationship. Each catalyst has an ozone abatement catalyst loaded thereon arranged in a stacked configuration between a source of the air stream and the passenger cabin. In an embodiment of the invention, at least the first two substrates 260, 262 adjacent the air stream comprise an iron-based alloy.

At least the first two substrates comprise an iron-based alloy, such as an iron-chromium alloy, in their inlet ends to mitigate any damage caused by the air stream. In an exemplary embodiment, each of the substrates has a diameter of at least 8.2 inches and a height of at least 0.8 inches. Typically, the substrates are made from an aluminum metal, as weight of the substrates is an important consideration in the catalyst system design. Ceramic and other metal substrates are typically not used in aircraft catalyst systems to minimize the weight of the catalyst system.

It has been determined, however, that there is an acceptable tradeoff in weight of the catalyst and durability of the catalyst system by providing a catalyst system in which the first two catalyst substrates adjacent the incoming air stream comprise an iron-based alloy. Suitable iron-based alloys include iron-chromium alloys. An example of an iron-chromium alloy comprises iron in the range of about 60 weight % to about 80.0 weight % chromium in the range of about 15 weight % to about 30 weight %, aluminum in the range of about 2 weight % to about 10 weight %, and lanthanum and cerium combined in an amount of less than about 1 weight %. In a more specific example, the iron-chromium alloy comprises iron in the range of about 70 weight % to about 80 weight %, chromium in the range of about 20 weight % to about 25 weight %, aluminum in the range of about 4 weight % to about 8 weight %, and lanthanum and cerium combined in an amount of less than about 0.5 weight %. In a specific embodiment of the invention, the iron-chromium alloy comprises iron in the range of about 71.8% to about 75.0%, chromium in the range of about 20.0% to about 22.0%, aluminum in the range of about 5.0% to about 6.0%, and lanthanum and cerium in the combined range of about 0.02% to about 0.15%.

In another embodiment, the iron-chromium alloy comprises iron in the range of about 76 weight % to about 80 weight %, chromium in the range of about 14 weight % to about 17%, aluminum in the range of about 5 weight % to about 6 weight %, carbon up to about 0.5 weight %, manganese up to about 1 weight %, silicon up to about 1 weight % and sulfur up to about 0.5 weight %. Another specific embodiment of the iron-chromium alloy comprises iron in the range of about 75.9% to about 80.3%, chromium in the range of about 14.7% to about 16.4%, aluminum in the range of about 5.0% to about 6.0%, carbon up to about 0.08%, manganese up to about 0.8%, silicon up to about 0.8% and sulfur up to about 0.01%.

In one embodiment, the iron-based alloy has a density in the range of about 6.9 g/cm³ to about 7.2 g/cm³.

The catalyst substrates are typically in the form of a honeycomb substrate 300 as shown in FIG. 3. The honeycomb 300 has an outer surface 302, and a plurality of channels 301 extending from an inlet end 304 to an outlet end 306. The channels 301 extend longitudinally along the axial length of the honeycomb and are bounded by wall elements. Typically, honeycombs are made from an aluminum metal.

The honeycomb 300 channels 301 are typically coated with catalytic material in the form of a washcoat. In this regard, a slurry can be prepared by means known in the art such as combining the appropriate amounts of the catalyst of this invention in powder form, with water. The resultant slurry is ball-milled to form a usable slurry. This slurry can now be used to deposit a thin film or coating of catalyst of this invention onto the monolithic carrier by means well known in the art. Optionally, an adhesion aid such as alumina, silica, zirconium silicate, aluminum silicates, zirconium acetate, organic polymers or silicones can be added in the form of an aqueous slurry or solution. A common method involves dipping the monolithic carrier into said slurry, blowing out the excess slurry, drying and calcining in air at a temperature of about 450° C. to about 600° C. for about 1 to about 4 hours. This procedure can be repeated until the desired amount of catalyst of this invention is deposited on said monolithic honeycomb carrier. It is desirable that the catalyst of this invention be present on the monolithic carrier in an amount in the range of about 1-4 g of catalyst per in³ of carrier volume and preferably from about 1.5-3 g/in³.

The specific catalyst utilized according to embodiments of the invention can be any catalyst that is suitable for treating aircraft cabin air. In one or more embodiments the catalyst includes a component such as Au, Ag, Ir, Pd, Pt, Rh, Ni, Co, Mn, Cu, Fe, vanadia, zeolite, titania, ceria and mixtures thereof and other compositions known for removing ozone, VOCs, NOx and other pollutants. These compositions can be used in metal or oxide form. Suitable supports that can be used in each embodiment described herein include refractory metal oxide such as alumina, titania, manganese oxide, manganese dioxide and cobalt dioxide. In one or more embodiments, the catalyst support can further include silica. One or more embodiments, a honeycomb support is used, wherein the honeycomb is a ceramic or metal. A specific type of catalyst that can be used according to one or more embodiments of the present invention is described in U.S. Pat. No. 5,422,331, the entire content of which is incorporated herein by reference. In particular, the catalyst may comprise (a) an undercoat layer comprising a mixture of a fine particulate refractory metal oxide and a sol selected from the class consisting of one or more of silica, alumina, zirconia and titania sols; and (b) an overlayer comprising a refractory metal oxide support on which is dispersed at least one catalytic metal component. The catalytic metal component may include a palladium component. The sol may be a silica sol. The overlayer refractory metal oxide comprises activated alumina. In one or more embodiments, the refractory metal oxide is a silica alumina comprising from about 5 to 50 percent by weight silica and from about 50 to 95 percent by weight alumina. In specific embodiments, the catalytic metal component comprises a palladium component and a manganese component, and the palladium may be dispersed on the refractory metal oxide with a palladium salt such as palladium tetraamine hydroxide or palladium tetraamine nitrate. The amount of the palladium component may be from about 50 to about 250 g/ft³.

Other suitable ozone abatement catalysts are described in U.S. Pat. Nos. 4,343,776; 4,206,083; 4,900,712; 5,080,882; 5,187,137; 5,250,489; 5,422,331; 5,620,672; 6,214,303; 6,340,066; 6,616,903; and 7,250,141, which are hereby incorporated by reference, are useful for the practice of the present invention.

An illustrative example is U.S. Pat. No. 6,616,903, which discloses a useful ozone treating catalyst comprises at least one precious metal component, specifically a palladium component dispersed on a suitable support such as a refractory oxide support. The composition comprises from 0.1 to 20.0 weight %, and specifically 0.5 to 15 weight % of precious metal on the support, such as a refractory oxide support, based on the weight of the precious metal (metal and not oxide) and the support. Palladium may be used in amounts of from 2 to 15, more specifically 5 to 15 and yet more specifically 8 to 12 weight %. Platinum may be used at 0.1 to 10, more specifically 0.1 to 5.0, and yet more specifically 2 to 5 weight %. Palladium may be used to catalyze the reaction of ozone to form oxygen. The support materials can be selected from the group recited above. In one embodiment, there can additionally be a bulk manganese component, or a manganese component dispersed on the same or different refractory oxide support as the precious metal, specifically palladium component. There can be up to 80, specifically up to 50, more specifically from 1 to 40 and yet more specifically about 5 to 35 weight % of a manganese component based on the weight of palladium and manganese metal in the pollutant treating composition. Stated another way, there is specifically about 2 to 30 and specifically 2 to 10 weight % of a manganese component. The catalyst loading is from 20 to 250 grams and specifically about 50 to 250 grams of palladium per cubic foot (g/ft³) of catalyst volume. The catalyst volume is the total volume of the finished catalyst composition and therefore includes the total volume of air conditioner condenser or radiator including void spaces provided by the gas flow passages. Generally, the higher loading of palladium results in a greater ozone conversion, i.e., a greater percentage of ozone decomposition in the treated air stream.

Another illustrative example from U.S. Pat. No. 6,616,903 comprises a catalyst composition to treat ozone comprising a manganese dioxide component and precious metal components such as platinum group metal components. While both components are catalytically active, the manganese dioxide can also support the precious metal component. The platinum group metal component specifically is a palladium and/or platinum component. The amount of platinum group metal compound specifically ranges from about 0.1 to about 10 weight % (based on the weight of the platinum group metal) of the composition. Specifically, where platinum is present it is in amounts of from 0.1 to 5 weight %, with useful and preferred amounts on pollutant treating catalyst volume, based on the volume of the supporting article, ranging from about 0.5 to about 70 g/ft³. The amount of palladium component specifically ranges from about 2 to about 10 weight % of the composition, with useful and preferred amounts on pollutant treating catalyst volume ranging from about 10 to about 250 g/ft³.

Another example of a suitable catalyst material can be found in U.S. Pat. No. 6,517,899, the entire content of which is incorporated herein by reference. U.S. Pat. No. 6,517,899 describes catalyst compositions comprising manganese compounds including manganese dioxide, including non stoichiometric manganese dioxide (e.g., MnO_{(1.5-2.0)}), and/or Mn₂O₃. Such manganese dioxides, which are nominally referred to as MnO₂ have a chemical formula wherein the molar ratio of manganese to oxide is about from 1.5 to 2.0, such as Mn₈O₁₆. Up to 100 percent by weight of manganese dioxide MnO₂ can be used in catalyst compositions to treat ozone and other undesired components in the air. Alternative compositions which are available comprise manganese dioxide and compounds such as copper oxide alone or copper oxide and alumina.

Useful manganese dioxides are alpha manganese dioxides nominally having a molar ratio of manganese to oxygen of from 1 to 2. Useful alpha manganese dioxides are disclosed in U.S. Pat. No. 5,340,562 to O'Young, et al.; also in O'Young, Hydrothermal Synthesis of Manganese Oxides with Tunnel Structures presented at the Symposium on Advances in Zeolites and Pillared Clay Structures presented before the Division of Petroleum Chemistry, Inc. American Chemical Society New York City Meeting, Aug. 25-30, 1991 beginning at page 342, and in McKenzie, the Synthesis of Birnessite, Cryptomelane, and Some Other Oxides and Hydroxides of Manganese, Mineralogical Magazine, December 1971, Vol. 38, pp. 493-502. Suitable alpha manganese dioxide can have a 2×2 tunnel structure which can be hollandite (BaMn₈ O₁₆xH₂O), cryptomelane (KMn₈O₁₆.xH₂O), manjiroite (NaMn₈O₁₆.xH₂O) and coronadite (PbMn₈O₁₆.xH₂O).

The catalyst composition may comprise a binder as described below with preferred binders being polymeric binders. The composition can further comprise precious metal components with preferred precious metal components being the oxides of precious metal, preferably the oxides of platinum group metals and most preferably the oxides of palladium or platinum also referred to as palladium black or platinum black. The amount of palladium or platinum black can range from 0 to 25%, with useful amounts being in ranges of from about 1 to 25 and 5 to 15% by weight based on the weight of the manganese component and the precious component.

It may also be desirable to use of compositions comprising the cryptomelane form of alpha manganese oxide, which also contain a polymeric binder A portion of the cryptomelane may be replaced by up to 25%, for example, from 15-25% parts by weight of palladium black (PdO). A suitable cryptomelane manganese dioxide has from 1.0 to 3.0 weight percent potassium, typically as K₂O, and a crystallite size ranging from 2 to 10 nm. The cryptomelane can be made by reacting a manganese salt including salts selected from the group consisting MnCl₂, Mn(NO₃)₂, MnSO₄ and Mn(CH₃COO)₂ with a permanganate compound. Cryptomelane is made using potassium permanganate; hollandite is made using barium permanganate; coronadite is made using lead permanganate; and manjiroite is made using sodium permanganate. It is recognized that the alpha manganese useful in the present invention can contain one or more of hollandite, cryptomelane, manjiroite or coronadite compounds. Even when making cryptomelane minor amounts of other metal ions such as sodium may be present. Useful methods to form the alpha manganese dioxide are described in the above references which are incorporated by reference.

The cryptomelane may be “clean” or substantially free of inorganic anions, particularly on the surface. Such anions could include chlorides, sulfates and nitrates which are introduced during the method to form cryptomelane. An alternate method to make the clean cryptomelane is to react a manganese carboxylate, preferably manganese acetate, with potassium permanganate. It has been found that the use of such a material which has been calcined is “clean”.

The adhesion of catalytic and adsorption compositions to surfaces, e.g., metal surfaces, may be improved by the incorporation of clay minerals as adhesion promoters. Such clay minerals include but are not limited to attapulgite, smectites (e.g., montmorillonite, bentonite, beidellite, nontronite, hectorite, saponite, etc.), kaolinite, talc, micas, and synthetic clays (e.g., Laponite sold by Southern Clay Products). The use of clay minerals in manganese dioxide catalyst slurries has been demonstrated to improve the adhesion of the resulting catalyst coatings to metal surfaces.

Additional suitable metal surface adhesion promoting materials for catalytic and adsorption compositions are water based silicone resin polymer emulsions The use of water based silicone polymer emulsions can improve the adhesion of e.g. manganese dioxide catalyst coatings to metal surfaces. In one embodiment, the benefit of the silicone polymer is obtained by incorporating the water based silicone latex emulsion into the catalyst slurry formulation prior to coating. In an additional embodiment, however, the benefit of the silicone polymer can be obtained by application of a dilute solution of the silicone latex over the dried catalyst coating. The silicone latex is believed to penetrate the coating, and upon drying, leaves a porous cross-linked polymer “network” which significantly improves adhesion of the coating.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A catalyst system for treating ozone in an air stream entering a passenger cabin of an aircraft, comprising a plurality of serially arranged, discrete substrates having an ozone abatement catalyst loaded thereon and arranged in a stacked configuration between a source of the air stream and the passenger cabin, at least the first two substrates adjacent the air stream comprising an iron-based alloy.

2. The catalyst system of claim 1, wherein each substrate comprises a honeycomb.

3. The catalyst system of claim 2, wherein at least the first two substrates comprise an iron-chromium alloy.

4. The catalyst system of claim 3, wherein the iron-chromium alloy comprises iron in the range of about 60 weight % to about 80.0 weight %, chromium in the range of about 15 weight % to about 30 weight %, aluminum in the range of about 2 weight % to about 10 weight %, and lanthanum and cerium combined in an amount of less than about 1 weight %.

5. The catalyst system of claim 4, wherein the iron-chromium alloy comprises iron in the range of about 70 weight % to about 80 weight%, chromium in the range of about 20 weight % to about 25 weight%, aluminum in the range of about 4 weight % to about 8 weight %, and lanthanum and cerium combined in an amount of less than about 0.5 weight %.

6. The catalyst system of claim 3, wherein the iron-chromium alloy comprises iron in the range of about 76 weight% to about 80 weight %, chromium in the range of about 14 weight % to about 17%, aluminum in the range of about 5 weight % to about 6 weight%, carbon up to about 0.5 weight %, manganese up to about 1 weight %, silicon up to about 1 weight % and sulfur up to about 0.5 weight %.

7. The catalyst system of claim 3, wherein the iron-based alloy has a density in the range of about 6.9 g/cm³ to about 7.2 g/cm³.

8. The catalyst system of claim 3, wherein substrates disposed downstream of at least the first two substrates comprise aluminum.

9. The catalyst system of claim 3, wherein substrates disposed downstream of at least the first two substrates comprise a ceramic material.

10. The catalyst system of claim 3, wherein the ozone abatement catalyst comprises a manganese component.

11. The catalyst system of claim 2, wherein the substrates are disposed within a canister in a spaced relationship

12. A method for treating ozone in an air stream entering a passenger cabin of an aircraft, comprising placing a plurality of serially arranged, discrete substrates having an ozone abatement catalyst loaded thereon between a source of the air stream and the passenger cabin, the first two substrates comprising an iron-based alloy.

13. The method of claim 12, wherein each substrate comprises a honeycomb and at least the first two substrates comprise an iron-chromium alloy.

14. The method of claim 13, wherein the iron-chromium alloy comprises iron in the range of about 60 weight % to about 80.0 weight % chromium in the range of about 15 weight % to about 30 weight %, aluminum in the range of about 2 weight % to about 10 weight %, and lanthanum and cerium combined in an amount of less than about 1 weight %.

15. The method of claim 14, wherein the iron-chromium alloy comprises iron in the range of about 70 weight % to about 80 weight%, chromium in the range of about 20 weight % to about 25 weight%, aluminum in the range of about 4 weight % to about 8 weight %, and lanthanum and cerium combined in an amount of less than about 0.5 weight %.

16. The method of claim 13, wherein the iron-chromium alloy comprises iron in the range of about 76 weight% to about 80 weight %, chromium in the range of about 14 weight % to about 17%, aluminum in the range of about 5 weight % to about 6 weight%, carbon up to about 0.5 weight %, manganese up to about 1 weight %, silicon up to about 1 weight % and sulfur up to about 0.5 weight %.

17. The method of claim 13, wherein the iron-based alloy has a density in the range of about 6.9 g/cm³ to about 7.2 g/cm³.

18. The method of claim 13, wherein the ozone abatement catalyst comprises a manganese component.

19. The method of claim 13, wherein the catalysts are disposed within a canister in a spaced relationship
